(19) United States
(12) Patent Application Publication
(10) Pub. No.: US 2002/0170483 A1
(43) Pub. Date: Nov. 21, 2002

(54) Integrated grease fitting protector and installation date recorder

(76) Inventor: James Parejko, Aurora, IL (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/859,047

(22) Filed: May 16, 2001

(51) Int. Cl. G09F 9/00

(52) U.S. Cl. 116/308; 116/307; 206/459.1

(57) ABSTRACT

An information recording device having an attachment element for attachment to a grease fitting of a bearing assembly and a recording device attached thereto having date indicia to record installation date and/or maintenance records. The recording device further includes a grease fitting protective cap to fit over and enclose the grease fitting.

### BACKGROUND OF INVENTION

1. Field of Invention

This invention is directed generally to bearing assemblies, and more particularly to a date recorder attachable to a grease fitting protector.

2. Background of the Invention

Bearing assemblies are installed in a broad variety of industrial applications and settings. The useful life of a bearing assembly varies widely depending upon the application, loads, and speeds experienced. To perform proper maintenance and upkeep on systems utilizing bearing assemblies it is useful to know the date on which various bearing assemblies have been installed. In the past, technical personnel have used markers to write the date of installation directly on the bearing assembly. However, some bearing assemblies have a useful life of 20 years or more, and often operate under harsh operating conditions. As a result, the markings are often removed due to various washdown procedures and generally wear away over time. Other methods have included etching the bearing assembly with the installation date. However, maintenance personnel often fail to carry proper etching tools or otherwise fail to mark the bearing assemblies with the installation date. Moreover, typical information provided is limited to date of manufacture, as opposed to installation date, which is undesirable because often bearing assemblies are purchased, placed into stock, and not installed for up to several years after date of manufacture. Thus, date of manufacture information is often not useful in determining the length of bearing assembly service.

Most bearing assemblies are equipped with a grease fitting to allow for the bearing assembly to be lubricated periodically. Typically, the grease fittings include a protective cover or cap to prevent contaminants from entering the bearing through the grease fitting during normal operation of the bearing. It is usually only removed to allow for lubricants to be added to the bearing. It is useful for maintenance personnel to record the dates of maintenance and lubrication to insure that the bearing assemblies are properly lubricated and maintained.

Accordingly, there is a need to provide maintenance personnel with a reliable method of recording the installation dates of bearing assemblies, as well as recording maintenance and lubrication records, that remains with the bearing assembly over time.

### SUMMARY OF THE INVENTION

The present invention is specifically directed to a recording device for recording the installation date and/or of maintenance records of a bearing assembly. The recording device is adapted to be attached to a grease fitting on the bearing assembly. In a preferred embodiment, the recording device includes an attachment element for attachment to a grease fitting on the bearing assembly. Most preferably, the attachment element is a ring or loop that fits over the grease fitting. Further, a recording device is tethered to the attachment element to allow for installation dates and/or maintenance records to be indicated on the recording device. Preferably the recording device includes date indicia that can be marked, clipped, or deformed to indicate a particular date. Pliers, snips, electrical pliers, scissors, or any tool that can create an indentation or mark in the recording device can be used to indicate the date. The date information may take several forms. For example, the recording device may include the twelve months of the year, or the four quarters of the year, along with the year (such as '01, '02, '03, etc.). The maintenance personnel can mark the date to indicate either the installation date or maintenance records.

The date indicia can also take many forms. It can come in the form of a sticker on the recording device, an element for writing the information, or can be directly molded into the recording device. In addition, an electronic device can also be included in the recording device. In fact, any method suitable for recording information can be used. In a preferred embodiment the attachment element and the recording device are an integral unit that is injection molded, with the various date information molded directly into the recording device. Of course, an integral unit is not required and the attachment element may be attached to the recording device by any suitable means.

In a most preferred embodiment, the recording device is also adapted to serve as the grease fitting protective cap. The grease fitting cap may be molded directly into the recording device. In this matter, the recording device is tethered to the grease fitting via the attachment element. The installation and/or recording information is recorded on the recording device and then the recording device is “capped” onto the grease fitting. The installation date/maintenance records are therefore preserved, being directly attached to the bearing assembly.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIG. 1 is a top view of the recording device of the present invention showing the attachment element that is tethered to the recording device.

FIG. 2 is a side view of the recording device shown in FIG. 1.

FIG. 3 is a perspective view of the recording device of the present invention attached to a grease fitting of a bearing assembly.

While the invention is susceptible to various modifications and alternative forms, specific embodiments thereof are shown by way of example in the drawings and will herein be described in detail. It should be specifically understood with respect to the drawings, that the drawings are of the preferred embodiment, and there are many other embodiments and forms in which the present invention may appear. It should also be understood that the drawings and detailed description thereof are not intended to limit the invention to the particular form disclosed, but on the contrary, the invention is to cover all modifications, equivalents and alternatives falling within the spirit and scope of the present invention or within the scope of the appended claims.

In addition, while the present invention is particularly useful in applications for use with bearing assemblies, it can be used in connection with any equipment, and the present invention may be used for any other application where the use of a recording device would be suitable.

### DETAILED DESCRIPTION OF THE PREFERRED EMBODIMENT

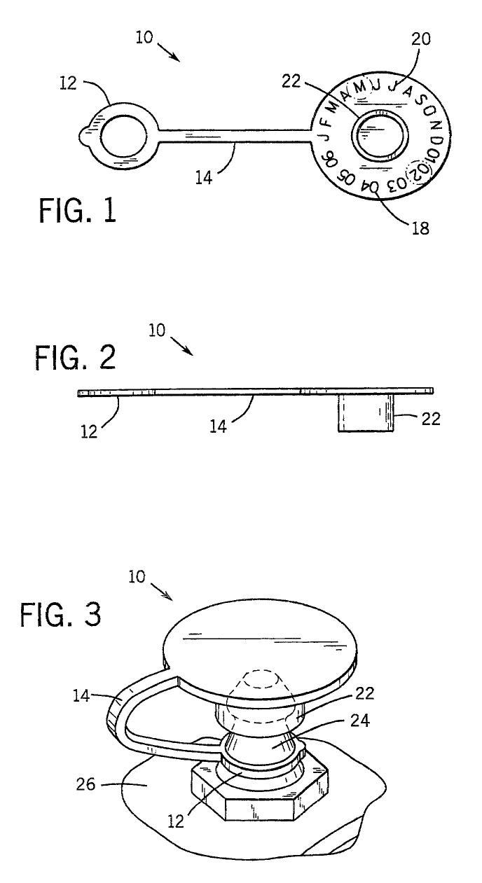

An information recording device 10 made in accordance with the principles of the present invention is depicted in FIGS. 1-3. As shown in FIG. 1, information recording device 10 includes attachment element 12 that is adapted for attachment to a grease fitting of a bearing assembly. The attachment element 12 is connected to a tether 14 which in turn is connected to recording device 16.

As shown in FIG. 1, recording device 16 includes date indicia, preferably including month indicia 20 and year indicia 18. The date indicia may take many forms including a sticker, areas that can be marked with a writing instrument, or as shown in FIG. 2, the indicia may be directly molded into the recording device. For example, the recording device may include the twelve months of the year (e.g., by numeric representation 1-12, the first letter of the month, etc.), or the four quarters of the year, along with the year (such as '01, '02, '03, etc.). The maintenance personnel can mark the date to indicate either the installation date or maintenance records. In addition, the recording device may be equipped with an electronic element that captures date information.

As shown in FIG. 2, the information recording device 10 preferably includes a grease fitting cap 22 that is adapted to fit over and enclose a grease fitting positioned on a bearing assembly. In this manner, the recording device can be permanently attached to the bearing assembly to provide information regarding the installation date and/or maintenance information regarding the bearing assembly. In a preferred embodiment, the date indicia is directly molded into the recording device. A maintenance person can clip, or otherwise deface, the date indicia on the recording device to provide a record of the installation date and/or or maintenance information. To improve the contrast, the indicia may be either indented or raised from the surrounding surface of the recording device. Furthermore, the indicia may be provided in a different color from the surrounding area to improve the visibility of the indicia. This may be accomplished by painting, spraying, rubbing a colored wax over the indicia, or any other suitable means of providing contrast between the indicia and the surrounding surface of the recording device.

FIG. 3 shows the information recording device 10 attached to a grease fitting 24 of a bearing assembly 26 and the grease fitting protector 22 of the recording device placed over the grease fitting 24. The information recording device 10 of the present invention is preferably molded as a single integral unit. Any suitable plastic can be used. Most preferably, a flexible plastic is used allowing the tether to flex when the attachment element is secured to the grease fitting and the grease fitting protector of the recording device is capped onto the grease fitting.

The disclosed embodiment provides an advantage over prior art methods of indicating the date of manufacture. The present invention provides a permanent record of installation date and/or maintenance records that remains attached to the bearing assembly. Further, the present invention provides a simpler way for maintenance personnel to record important data relating to the bearing assembly.

Although the present invention is advantageously injected molded as a single integral unit, those skilled in the art will appreciate that any number of different ways of attaching the recording device the grease fitting may be used without departing from the present invention.

While certain features and embodiments of the invention have been described herein, it will be readily understood that the invention encompasses all modifications and enhancements within the scope and spirit of the present invention.

1. An information recording device comprising:
an attachment element adapted for attachment to a grease fitting;
a tether having a first end connected to the attachment element; and
a recording device attached to the tether;
the recording device including an area to include date indicia.

2. The information recording device of claim 1, wherein the attachment element comprises a ring that fits over the grease fitting.

3. The information recording device of claim 1, wherein the recording device includes date indicia representing the months of the year.

4. The information recording device of claim 1, wherein the recording device includes date indicia including various years.

5. The information recording device of claim 4, wherein the recording device further includes date indicia representing the months of the year.

6. The information recording device of claim 4, wherein the recording device further includes date indicia including the four quarters of the year.

7. The information recording device of claim 1, wherein the recording device includes date indicia and the recording device further includes a grease fitting cap.

8. The information recording device of claim 7, wherein the recording device includes date indicia representing the months of the year.

9. The information recording device of claim 7, wherein the recording device includes date indicia including various years.

10. The information recording device of claim 9, wherein the recording device further includes date indicia representing the months of the year.

11. The information recording device of claim 9, wherein the recording device further includes date indicia including the four quarters of the year.

12. The information recording device of claim 1, wherein the attachment element, tether, and recording device are an integral injection molded unit.

13. The information recording device of claim 12, wherein, date indicia is injection molded into the recording device.

14. The information recording device of claim 13, wherein the recording device further includes a grease fitting cap.

15. The information recording device of claim 13, wherein the recording device includes date indicia representing the months of the year.

16. The information recording device of claim 13, wherein the recording device includes date indicia including various years.

17. The information recording device of claim 16, wherein the recording device further includes date indicia representing the months of the year.

18. The information recording device of claim 16, wherein the recording device further includes date indicia including the four quarters of the year.

19. The information recording device of claim 1, wherein the recording device includes an electronic recording element.
